(19) United States
(12) Patent Application Publication
(10) Pub. No.: US 2020/0079060 A1
(43) Pub. Date: Mar. 12, 2020

(54) MULTI-LAYER FILM

(71) Applicant: SABIC GLOBAL TECHNOLOGIES B.V., BERGEN OP ZOOM (NL)

(72) Inventors: Ling FAN, Geleen (NL); Jana HRACHOVA, Geleen (NL); Bart VAN DEN ESSCHERT, Geleen (NL); Jun ZHOU, Geleen (NL); Feng GONG, Geleen (NL)

(21) Appl. No.: 16/462,723

(22) PCT Filed: Nov. 15, 2017
(86) PCT No.: PCT/CN2017/111119

§ 371 Date: May 21, 2019

Related U.S. Application Data
(63) Continuation-in-part of application No. PCT/CN2017/111119, filed on Nov. 15, 2017.

(30) Foreign Application Priority Data
Dec. 19, 2016 (CN) 201611176087.3

(51) Int. Cl. B32B 27/08; B32B 27/32

(52) U.S. Cl. CPC B32B 27/08; B32B 27/327; B32B 2250/242; B32B 2307/72; B32B 2270/00; B32B 2439/70

(57) ABSTRACT

It relates to a multi-layer film for seal-peel applications, an article comprising said film and the use of said film.

The invention relates to a multi-layer film for seal-peel applications, an article comprising said film and the use of said film.

Films for seal-peel applications are heat sealable-films, which may be heat sealed to themselves or to a substrate, that have a limited peel strength, so as to be easy to open along the seal.

Heat-sealable films used in the packaging field, especially in the food packaging field, have often to be easily detachable along the seals, in order to be removed or to allow opening of the wrap. In such cases the peel strength should correspond to a consumer friendly opening force.

To achieve that heat-sealable films of polyolefin materials have been proposed, generally comprising a support layer and a sealing layer. Such films are usually called seal peel films or films for seal-peel and/or easy-open applications. Such films are known for example from US20020013415.

However, despite previous research in the field, there is always a continuous need for films with an improved properties, especially improved adhesion to different substrates, particularly polar substrates, such as for example polyethylene terephthalate (PET) substrates and/or a wide sealing temperature window and/or a low sealing temperature.

Therefore, it is the object of the invention to provide multi-layer films film for seal-peel applications having a good adhesion when heat sealed, especially on polar substrates, such as for example PET substrate, and/or a wide sealing temperature window and/or a low sealing temperature.

This object is achieved by a multi-layer film comprising at least two layers, namely a cover layer and a seal layer, whereby the a seal layer comprises or consists of between 25 and 80 wt. % of EVA and between 20 and 75 wt. % of LLDPE based on the total weight of the layer, whereby the EVA comprises a first EVA and a second EVA. Having two different EVAs may thereby contribute to having a wider sealing temperature window and/or allow more flexibility regarding said window and/or a low sealing temperature, preferably between 80° C. and 150° C., further preferred between 80° and 120° C., further preferred between 80° C. and 100° C. or between 90° C. and 110° C.

The sealing temperature window is thereby the range of temperature at which heat sealing on a PET substrate may be achieved to get a seal strength, especially for example with a strip width of 15 mm and a separation rate of 200 mm/min, of for example between 2.2 and 9 N/15 mm, preferably of between 2.5 and 8.5 N/15 mm, further preferred between 2.7 to 8 N/15 mm as determined by ASTM F88 method C. The standard testing condition ASTM F88 method C were as follows: dwell time was 1.5 second, pressure was 4 bar, width and length of sealing bar size was 10 mm*150 mm. a separation rate of 200 mm/min, sealing temperature may be for example from 80° C. to 150° C., preferably at 80° C. and/or 90° C. and/or 110° C. and/or 130° C. and/or 150° C.

The present invention may thereby especially allow that a higher peel strength (preferably determined as explained above), preferably for example >2 N/15 mm, may be achieved with a relatively low sealing temperature, especially for example between 80° C. and 90° C., preferably with a sealing temperature of 80° C. and/or 90° C.

A first EVA and a second EVA may thereby by at least one of their properties, especially for example differ by their vinyl acetate content and/or their melt flow rate (MFR). The difference in MFR may be for example at least 25%, further preferred at least 30% of the highest value. The difference in vinyl acetate content may be for example at least 10 wt.%, preferably at least 20 wt. %, further preferred at least 25 wt. %, further preferred at least 30 wt. %, further preferred at least 35 wt. %, further preferred at least 40 wt. %. This may further contribute to widen the sealing temperature window.

One of the first or second EVAs may have a vinyl acetate content below 20 wt. %, preferably below 15 wt. %, further preferred below 10 wt. %, while the other one of the first or second EVA may have a vinyl acetate content above 20 wt. % preferably above 25 wt. %, further preferred above 30 wt. %, further preferred above 40 wt. % based on the total weight of the respective EVA. This may further contribute to widen the sealing temperature window.

Moreover, the EVA with the highest vinyl acetate content and/or the highest melt flow rate of the first and second EVAs may be present in the seal layer in amount of between 30 wt. % and 58 wt. %, preferably between 37 wt. % and 50 wt. % based on the total weight of the seal layer and/or based on the total weight of EVA in the seal layer. This may further contribute to widen the sealing temperature window and/or to increase the peel strength, especially at a lower temperature, like for example at a temperature between 80° C. and 90° C.

Moreover, the EVA with the lowest vinyl acetate content and/or the lowest melt flow rate of the first and second EVAs may be present in the seal layer in amount of between 2 wt. % and 15 wt. %, preferably between 3 wt. % and 10 wt. % based on the total weight of the seal layer and/or based on the total weight of EVA in the seal layer. This may further contribute to widen the sealing temperature window and/or to increase the peel strength, especially at a lower temperature, like for example at a temperature between 80° C. and 90° C.

Linear low density polyethylene (LLDPE) may be a copolymer of ethylene and at least one α-olefin, such as for example 1-butene, 1-pentene, 1-hexene, 1-octene, or 4-methylpentene-1, most preferably 1-butene, 1-hexene or 1-octene. An ethylene copolymer may especially be a polyolefin plastomer or a polyolefin elastomer. Preferably, the alpha-olefin co monomer of LLDPE may be present for example in an amount of about 1 to about 25, preferably 5 to about 20 percent by weight of the ethylene-alpha olefin copolymer, preferably of 5 to about 20 percent by weight of the ethylene-alpha olefin copolymer, more preferably an amount of from about 7 to about 15 percent by weight of the ethylene-alpha olefin copolymer. LLDPE, as used herein, may be produced for example using metallocene and/or Ziegler-Natta catalysts.

Preferably, LLDPE according to the invention has a density between 0.850 and <0.945 g/cm³, more preferably between 0.900 to 0.935 g/cm³, further preferred between 0.915 to 0.927 g/cm³. For purpose of the invention, the density of LLDPE is determined using ISO1872-2.

Preferably, the melt flow index of the LLDPE ranges from 0.3 to 15 g/10 min, from 1 to 10 g/10 min, for example from 2 to 6 g/10 min, for example from 2.5 to 3.7 g/10 min. For purpose of the invention, the melt flow index is determined herein using ISO1133:2011 (190° C./2.16 kg).

The amount of linear low density polyethylene in the seal layer may be preferably between 20% and 75% by weight based on the total weight of the layer, between 25% and 70% by weight based on the total weight of the layer or between 45 and 60% by weight based on the total weight of the layer.

Ethylene vinyl acetate (EVA) is a copolymer of ethylene and vinyl acetate.

Preferably, the melt flow index of the EVA ranges from 1 to 35 g/10 min, for example from 2 to 30 g/10 min, for example from 1.5 to 20 g/10 min, for example from 1.5 to 4 g/10 min or from 10 to 20 g/10 min. For the purpose of the invention, the melt flow index of EVA is determined herein using ASTM-D1238 (190° C./2.16 kg).

Preferably, EVA according to the invention has a density between 0.900 and 0.999 g/cm³, more preferably between 0.910 to 0.965 g/cm³, further preferred between 0.920 to 0.960 g/cm³. For purpose of the invention, the density of EVA is determined using ISO1183.

The vinyl acetate content of the EVA may be for example between 4 and 50 wt. %, preferably between 8 and 45 wt. %, further preferred between 10 and 40 wt. %, further preferred between 15 and 35 wt. %. This may contribute to a good adhesion on polar substrates, such as for example PET substrates.

The amount of EVA in the seal layer may be preferably be between 25% and 80% by weight based on the total weight of the layer, between 30% and 75% by weight based on the total weight of the layer or between 30 and 49% by weight based on the total weight of the layer. This may contribute to a good adhesion on polar substrates, such as for example PET substrates.

A multi-layer film according to the invention may comprise at least one, preferably exactly one, seal layer.

A multi-layer film according to the invention may comprise at least one, preferably at least two, further preferred at least three, further preferred at least four, further preferred at least five cover layer(s).

That the seal layer may preferably consist of between 25 and 80 wt. % of EVA and between 20 and 75 wt. % of LLDPE based on the total weight of the layer may mean that the seal layer may preferably not comprise any further polymer and/or may not comprise any further polyolefin and/or may not comprise any LDPE.

Preferably, when the EVA content of the seal layer is <50 wt. % the vinyl acetate content of the EVA may be >20 wt. %. Alternatively, when the EVA content of the seal layer is >50 wt. % the vinyl acetate content of the EVA may be <20 wt. %. This may contribute to a good adhesion on polar substrates, such as for example PET substrates.

The seal layer of a multilayer-film according to the invention may preferable for example comprise only one LLDPE and/or not two or more different LLDPE's that may differ from example on density and/or on MFR.

The seal layer of a multilayer-film according to the invention may preferable for example comprise only one EVA and/or not two or more different EVA's that may differ from example on vinyl acetate content and/or on MFR.

A multi-layer film according to the invention may comprise a first LDPE cover layer arranged on and in contact with the seal layer and a second cover layer of a blend of LLDPE and LDPE arranged on and in contact with the LDPE cover layer.

A multi-layer film according to the invention may comprise a first LDPE cover layer arranged on and in contact with the seal layer, a second cover layer of a blend of LLDPE and LDPE arranged on and in contact with the LDPE cover layer, a third adhesive cover layer arranged on and in contact with the LLDPE/LDPE blend cover layer and a fourth nylon cover layer arranged on and in contact with the adhesive cover layer. The seal layer and the nylon cover layer thereby represent the outermost layers.

The production processes of LDPE, HDPE and LLDPE are summarized in Handbook of Polyethylene by Andrew Peacock (2000; Dekker; ISBN 0824795466) at pages 43-66. The catalysts can be divided in three different subclasses including Ziegler Natta catalysts, Phillips catalysts and single site catalysts. The latter class is a family of different classes of compounds, metallocene catalysts being one of them. As elucidated at pages 53-54 of said Handbook a Ziegler-Natta catalyzed polymer is obtained via the interaction of an organometallic compound or hydride of a Group I-Ill metal with a derivative of a Group IV-VIII transition metal. An example of a (modified) Ziegler-Natta catalyst is a catalyst based on titanium tetra chloride and the organometallic compound triethylaluminium. A difference between metallocene catalysts and Ziegler Natta catalysts is the distribution of active sites. Ziegler Natta catalysts are heterogeneous and have many active sites. Consequently polymers produced with these different catalysts will be different regarding for example the molecular weight distribution and the comonomer distribution.

The technologies suitable for the LLDPE manufacture include but are not limited to gas-phase fluidized-bed polymerization, polymerization in solution, and slurry polymerization.

Preferably, the density of the low density polyethylene (LDPE) ranges from 0.915 to 0.932 g/cm³, further preferred for example from 0.917 to 0.926 g/cm³. Preferably, the melt flow index as determined using ISO1133:2011 (190° C./2.16 kg) ranges from 0.01 to 4 g/10 min, for example from 0.09 to 3 g/10 min, for example from 0.1 to 1 g/10 min, for example from 0.2 to 0.6 g/10 min.

The LDPE applied in the present film may be produced by use of autoclave high pressure technology and by tubular reactor technology.

Preferably, the density of the HDPE ranges from 0.940 to 0.965 g/cm³. Preferably, the melt flow index as determined using ISO1133:2011 (190° C./2.16 kg) ranges from 0.1 to 4 g/10 min, for example from 0.3 to 3 g/10 min, for example from 0.2 to 2 g/10 min, for example from 0.5 to 1.5 g/10 min.

The components of the seal layer according to the invention may preferably add up to 100 wt. % of the seal layer.

The thickness of multi-layer film of the invention may range for example from 15 to 200 μm, for example from 50 to 150 μm, especially for example between 60 to 125 μm. Not all layers in the multi-layer film of the invention need to have the same thickness. For example, one or more layers in the multi-layer film may be thicker than the other layers, especially for example to increase the stability of the production process. Each layer or all layers may have a thickness of for example between 10 and 23 μm, preferably between 15 and 25 μm.

For example, each layer in the multi-layer film of the invention may comprise an amount of additives of 0 to 10 wt. %, especially for example 0 to 8 wt. % based on the total weight of the layer, wherein the sum of the polymer(s) and the additives is 100 wt. % based on the total weight of the layer.

Additives may thereby especially for example be UV stabilizers, antistatic agents, slip/anti-block agents, fluor elastomers used as polymer processing aids and/or mixtures of two or more thereof. Especially for example an erucamide and/or an oleamide and/or silica and/or talc.

Each layer may also contain appropriate amounts of other additives such as for example fillers, antioxidants, pigments and polymers depending on the specific use of the multi-layer film. Typically, additives may be present in a layer in an amount of 10 to 10000ppm, for example in an amount of 100 to 5000 ppm based on the layer. Therefore, the invention also relates to a multi-layer film wherein one or more layers further comprise(s) one or more additives or other additives.

The multi-layer films of the present invention may for example have peel strength on PET of between 1 and 20 N/15 mm, preferable between 1.5 and 15 N/15 mm, further preferred between 1.5 and 8.5 N/15 mm, further preferred between 3 and 8 N/15 mm or between 3 and 6 N/15 mm, especially preferred between 2.2 and 9 N/15 mm, further preferred of between 2.5 and 8.5 N/15 mm, further preferred between 2.7 to 8 N/15 mm, especially for example with a sealing temperature between 80° C. and 150° C., preferably at 80° C. and/or 90° C. and/or 100° C. and/or 110° C. and/or 130° C. and/or 150° C. This may contribute to achieve a sufficiently easy opening

Peel strength may be measured according to ASTM F88 method C on PET as a substrate with a strip width of 15 mm, a separation rate of 200 mm/min and a sealing temperature between 80° C. and 150° C., preferably between 90° C. and 150° C., whereby samples are allowed to cool down for at least 72 h before measuring. The standard testing condition was follow: dwell time was 1.5 second, pressure was 4 bar, width and length of sealing bar size was 10 mm*150 mm, a separation rate of 200 mm/min, sealing temperature was from 80° C. to 150° C., preferably at 80° C. and/or 90° C. and/or 110° C. and/or 130° C. and/or 150° C.

The seal layer may preferably be obtained by melt blending LLDPE and EVA for example at a temperature between 120 and 200° C., preferably between 155 and 180° C., further preferred at a temperature between 155 and 165° C. or between 170 and 180° C. Melt blending the LLDPE and EVA of the seal layer at a lower temperature may thereby contribute to improve the peel strength.

The present invention also concerns an article and/or packaging comprising a multi-layer film according to the invention.

Furthermore, the present invention also concerns the use of the multi-layer film according to the invention for food packaging applications.

It is further noted that the invention relates to all possible combinations of features described herein, preferred in particular are those combinations of features that are present in the claims.

It is further noted that the term ‘comprising’ does not exclude the presence of other elements. However, it is also to be understood that a description on a product comprising certain components also discloses a product consisting of these components.

The invention is now further explained by way of the following examples.

### EXAMPLES

As shown in Table 1 below, the seal layer was compounded in a ZSK-26MC twin screw extruder from W&P. Maximum extrusion temperature was 170 and 160° C. for NT and LT conditions respectively. Similarly melt temperature was 175° C. and 162° C., screw speed was 300 rpm and 250 rpm again for NT and LT conditions respectively. Output was 15 kg/hour in both NT and LT conditions.

TABLE 1

| Parameters | UOM | *NT | *LT |
|---|---|---|---|
| Feed (Zone 0) Temp | ° C. | 50 | 50 |
| Zone 1 Temp | ° C. | 100 | 100 |
| Zone 2 Temp | ° C. | 130 | 130 |
| Zone 3 Temp | ° C. | 140 | 130 |
| Zone 4 Temp | ° C. | 150 | 130 |
| Zone 5 Temp | ° C. | 160 | 125 |
| Zone 6 Temp | ° C. | 160 | 125 |
| Zone 7 Temp | ° C. | 160 | 125 |
| Zone 8 Temp | ° C. | 160 | 115 |
| Zone 9 Temp | ° C. | 160 | 110 |
| Zone 10 Temp | ° C. | 160 | 100 |
| Die Temp | ° C. | 170 | 160 |
| Screw speed | rpm | 300 | 250 |
| Throughput | kg/hr | 15 | 15 |
| Tmelt | % | 175 | 162 |

Normal temperature conditions (NT) and lower temperature conditions (LT) for the compounding are reported in Table 1 above.

Five different seal layers 1, 2, 3a, 3b and 4 were obtained with the compositions as presented in Table 2 below. 1, 2, 3a and 3b are comparative, while 4 is according to the present invention.

TABLE 2

| | EVA | | PE | | Compound | |
|---|---|---|---|---|---|---|
| | | EVA | | PE | parameter | |
| No. | Grade | wt % | Grade | wt % | MI | Processing |
| 1 | ELVAX 460 | 69 | 6318BE | 31 | 2.65 | NT |
| 2 | EVAFLEX | 35 | 6318BE | 65 | 7.2 | NT |
| | EV250 | | | | | |
| 3.a | EVAFLEX | 44 | 6318BE | 56 | 8.28 | NT |
| | EV250 | | | | | |
| 3.b | EVAFLEX | 44 | 6318BE | 56 | 8.28 | LT |
| | EV250 | | | | | |
| 4 | LEVAMELT | 45/5 | 6318BE | 50 | 2.84 | NT |
| | 450/ELVAX | | | | | |
| | 760A | | | | | |

As EVAs, three Dupont grades ELVAX460, LEVAMELT 450 and EVAFLEX EV250 (Dupont-Mitsui) were used. Moreover, LEVAMELT 450 from Lanxess was also used as EVA. The EVAs used are presented in Table 5 below. As LLDPE SABIC grade 6318BE was used. Seal layer 3b has been produced using lower temperature (LT) compounding conditions as reported above in Table 1.

The melt flow index of the compound may be determined using ASTM-D1238 (190 C/2.16 KG).

3 layer films were produced on a Labtech, LF400COEX multilayer extrusion blow film machine as indicated below in Table 3, BUR was 2, die gap was 2.0, total thickness was 50 micron.

A second cover layer comprising 30 wt. % of low density polyethylene of SABIC grade 2201H0W and 70 wt. % of linear low density polyethylene of SABIC grade 6118NSF is arranged in contact with the first cover layer. A first cover layer of low density polyethylene of SABIC grade 2201HOW is arranged in contact with the seal layer.

The thicknesses of second cover layer, the first cover layer and the seal layer were 17.5 microns, 17.5 microns and 15 microns respectively. The extrusion temperatures for the second cover layer, the first cover layer and the seal layer were 210° C., 210° C. and 175° C., respectively.

TABLE 3

| Layer | Profile | Layer | | Adaptor | Barrel 4 | Barrel 3 | Barrel 2 | Barrel 1 |
|---|---|---|---|---|---|---|---|---|
| information | (%) | ° C. | Pipe ° C. | ° C. | ° C. | ° C. | ° C. | ° C. |
| Second | 35 | 210 | 210 | 210 | 210 | 210 | 190 | 170 |
| cover layer | | | | | | | | |
| First | 35 | 210 | 210 | 210 | 210 | 210 | 190 | 170 |
| cover layer | | | | | | | | |
| Seal layer | 30 | 210 | 175 | 175 | 175 | 175 | 175 | 125 |

After a corona treatment with a CTP-2000K Plasma generator provided on the 3 layer films, the 3 layers film above was laminated to a 15 micron biaxially oriented nylon film with an adhesive substance, namely Liofol LA2788, using a FM380 lamination machine from Simeile. The coating weight was 2.85 g/m2.

Table 4 shows the peel strength values in N/15 mm for different seal temperatures obtained with the 3 layer films above (see Table 3) with different seal layers 1, 2, 3a and 3b (see Table 2).

TABLE 4
peel strength values (N/15 mm)

| | Seal temperature | | | | |
|---|---|---|---|---|---|
| | 80° C. | 90° C. | 110° C. | 130° C. | 150° C. |
| Seal layer No. 1 | 1.99 | 1.76 | 6.43 | 8.11 | 10.86 |
| Seal layer No. 2 | 0.79 | 3.68 | 4.50 | 3.50 | 4.92 |
| Seal layer No. 3a | 0.91 | 1.93 | 3.52 | 3.00 | 4.10 |
| Seal layer No. 3b | 0.43 | 0.72 | 5.60 | 4.60 | 6.14 |
| Seal layer No. 4 | 2.81 | 4.01 | 5.72 | 5.00 | 7.07 |

Peel strength has been measured according to ASTM F88 method C, after keeping under room temperature 72 hours, the film was sealed to a 250 micron PET film with a strip width of 15 mm by a HSG-C seal machine from Brugger. The standard testing condition was follow: dwell time was 1.5 second, pressure was 4 bar, width and length of sealing bar size was 10 mm*150 mm, sealing temperature was from 80° C. to 150° C., separation rate 200 mm/min. As can be seen above, the sealing temperature window at which heat sealing on a PET substrate may be achieved to get a seal strength with a strip width of 15 mm and a separation rate of 200 mm/min of between 2.5 and 8 N/15 mm, preferably between 2.7 to 8 N/15 mm as determined by ASTM F88 method C is broadened for seal layer 4 according to the invention compared to seal layers 1, 2, 3a and 3b, as comparative examples. Especially a higher peel strength may be achieved with a sealing temperature between 80° C. and 90° C., preferably with a sealing temperature of 80° C. and/or 90° C.

TABLE 5
EVAs used

| | | | VA content | |
|---|---|---|---|---|
| Grade | Vendor | MI | (wt. %) | density |
| ELVAX460 | Dupont | 2.5 | 18 | 0.941 |
| EVAFLEX | Dupont-Mitsui | 15 | 28 | 0.950 |
| EV250 | | | | |
| LEVAMELT | Lanxess | 3 | 45 | 0.99 |
| 450 | | | | |
| ELVAX 760A | Dupont | 2 | 9.3 | 0.93 |

1. A multi-layer film for seal-peel application comprising at least two layers, namely a cover layer and a seal layer, whereby the seal layer comprises between 25 and 80 wt. % of EVA and between 20 and 75 wt. % of LLDPE based on the total weight of the layer, whereby the EVA comprises a first EVA and a second EVA.

2. The multi-layer film according to claim 1, wherein the LLDPE has a density between 0.850 and <0.945 g/cm³.

3. The multi-layer film according to claim 1, wherein the melt flow index of the LLDPE ranges from 0.3 to 15 g/10 min.

4. The multi-layer film according to claim 1, wherein the amount of LLDPE in the seal layer is between 20% and 75% by weight based on the total weight of the layer.

5. The multi-layer film according to claim 1, wherein the amount of EVA in the seal layer is between 25% and 80% by weight based on the total weight of the layer.

6. The multi-layer film according to claim 1, wherein the melt flow index of the EVA ranges from 1 to 35 g/10 min.

7. The multi-layer film according to claim 1, wherein the vinyl acetate content of the EVA is between 4 and 50 wt. %.

8. The multi-layer film according to claim 1, wherein one of the first or second EVAs has a vinyl acetate content below 20 wt. %, while the other one of the first or second EVA has a vinyl acetate content above 20 wt. %, based on the total weight of the respective EVA.

9. The multi-layer film according to claim 1, wherein the seal layer consists of between 25 and 80 wt. % of EVA and between 20 and 75 wt. % of LLDPE based on the total weight of the layer.

10. The multi-layer film according to claim 1, wherein when the EVA content of the seal layer is <50 wt. % the vinyl acetate content of the EVA is >20 wt. % or when the EVA content of the seal layer is >50 wt. % the vinyl acetate content of the EVA is <20 wt. %.

11. The multi-layer film according to claim 1, wherein the EVA with the highest vinyl acetate content and/or the highest melt flow rate of the first and second EVAs is present in the seal layer in amount of between 30 wt. % and 58 wt. %, based on the total weight of the seal layer and/or based on the total weight of EVA in the seal layer.

12. The multi-layer film according to claim 1, wherein the EVA with the lowest vinyl acetate content and/or the lowest melt flow rate of the first and second EVAs is present in the seal layer in amount of between 2 wt. % and 15 wt. %, based on the total weight of the seal layer and/or based on the total weight of EVA in the seal layer.

13. Multi layerThe multi-layer film according to claim 1, wherein the film has a peel strength on PET of between 1 and 20 N/15 mm.

14. Article and/or packaging comprising a the multi-layer film according to claim 1.

15. (canceled)

16. The multi-layer film according to claim 1,
wherein the LLDPE has a density between 0.900 to 0.935 g/cm³,
wherein the melt flow index of the LLDPE ranges from 1 to 10 g/10 min,
wherein the amount of LLDPE in the seal layer is between 25% and 70% by weight based on the total weight of the layer,
wherein the amount of EVA in the seal layer is between 30% and 75% by weight based on the total weight of the layer,
wherein the melt flow index of the EVA ranges from 2 to 30 g/10 min,
wherein the vinyl acetate content of the EVA is between 8 and 45 wt. %,
wherein when the EVA content of the seal layer is <50 wt. % the vinyl acetate content of the EVA may be >20 wt. % and when the EVA content of the seal layer is >50 wt. % the vinyl acetate content of the EVA may be <20 wt. %, and
wherein the film has a peel strength on PET of 1.6 and 12 N/15 mm.

17. The multi-layer film according to claim 1,
wherein the LLDPE has a density between 0.915 to 0.927 g/cm³,
wherein the melt flow index of the LLDPE ranges from 2 to 6 g/10 min,
wherein the amount of LLDPE in the seal layer is between 51 and 70% by weight based on the total weight of the layer,
wherein the amount of EVA in the seal layer is between 30 and 49% by weight based on the total weight of the layer,
wherein the melt flow index of the EVA ranges from 2 to 20 g/10 min,
wherein one of the first or second EVAs has a vinyl acetate content below 10 wt. %,
while the other one of the first or second EVA may have a vinyl acetate content above 30 wt. %, based on the total weight of the respective EVA,
wherein when the EVA content of the seal layer is <50 wt. % the vinyl acetate content of the EVA may be >20 wt. %, and
wherein when the EVA content of the seal layer is >50 wt. % the vinyl acetate content of the EVA may be <20 wt. %.

18. The multi-layer film according to claim 1,
wherein the LLDPE has a density between 0.915 to 0.927 g/cm³,
wherein the melt flow index of the LLDPE ranges from 2 to 6 g/10 min,
wherein the seal layer consists of between 25 and 80 wt. % of EVA and between 20 and 75 wt. % of LLDPE based on the total weight of the layer,
wherein when the EVA content of the seal layer is <50 wt. % the vinyl acetate content of the EVA may be >20 wt. %,
wherein when the EVA content of the seal layer is >50 wt. % the vinyl acetate content of the EVA may be <20 wt. %,
wherein the EVA with the highest vinyl acetate content and/or the highest melt flow rate of the first and second EVAs is present in the seal layer in amount of between 37 wt. % and 50 wt. % based on the total weight of the seal layer and/or based on the total weight of EVA in the seal layer,
wherein the EVA with the lowest vinyl acetate content and/or the lowest melt flow rate of the first and second EVAs is present in the seal layer in amount of between 3 wt. % and 10 wt. %. based on the total weight of the seal layer and/or based on the total weight of EVA in the seal layer, and
wherein the film has a peel strength on PET of between 1 and 20 N/15 mm.

19. The multi-layer film according to claim 1, wherein the melt flow index of the EVA ranges from 2 to 3 g/10 min or from 10 to 20 g/10 min.
